(19) United States
(12) Patent Application Publication
(10) Pub. No.: US 2025/0338173 A1
(43) Pub. Date: Oct. 30, 2025

(54) METHOD AND APPARATUS FOR MAINTAINING CANDIDATE CELL CONFIGURATION, AND DEVICE AND STORAGE MEDIUM

(71) Applicant: Beijing Xiaomi Mobile Software Co., Ltd., Beijing (CN)

(72) Inventors: Yumin WU, Beijing (CN); Yi XIONG, Beijing (CN)

(21) Appl. No.: 18/864,974

(22) PCT Filed: May 12, 2022
(86) PCT No.: PCT/CN2022/092528

§ 371 Date: Nov. 12, 2024

(51) Int. Cl. H04W 28/086

(52) U.S. Cl. CPC H04W 28/086

(57) ABSTRACT

A method for maintaining candidate cell configuration is performed by a first network node and includes: initiating an update process on candidate cell configuration or candidate cell group configuration with a second network node; wherein the first network node requests the candidate cell configuration or the candidate cell group configuration, and the second network node provides the candidate cell configuration or the candidate cell group configuration.

### CROSS-REFERENCE TO RELATED APPLICATION

The present application is a U.S. National Stage of International Application No. PCT/CN2022/092528, filed on May 12, 2022, the contents of which are incorporated herein by reference in their entirety.

### TECHNICAL FIELD

The present disclosure relates to the field of communications and, in particular, to a method and an apparatus for maintaining candidate cell configuration, and a device and a storage medium.

### BACKGROUND

In 5th Generation System (5G), network devices can provide pre-configured candidate cell groups to terminal devices. The network device can subsequently activate or deactivate a pre-configured candidate cell group through activation signaling, without the need to re-provide configuration of the cell group.

When the pre-configured candidate cell group is determined through negotiation among multiple network nodes on the network side, how to update the configuration of the pre-configured candidate cell group, so that the terminal side and the network side, as well as multiple network nodes on the network side, have the same understanding of the updated configuration is an urgent problem to be solved.

### SUMMARY

According to an aspect of the present disclosure, a method for maintaining candidate cell configuration is provided, the method is performed by a first network node, and the method includes: initiating an update process on candidate cell configuration or candidate cell group configuration with a second network node; where the first network node requests the candidate cell configuration or the candidate cell group configuration, and the second network node provides the candidate cell configuration or the candidate cell group configuration.

According to an aspect of the present disclosure, a method for maintaining candidate cell configuration is provided, the method is performed by a second network node, and the method includes: initiating an update process on candidate cell (group) configuration with a first network node; where the first network node requests the candidate cell configuration or the candidate cell group configuration, and the second network node provides the candidate cell configuration or the candidate cell group configuration.

According to an aspect of the present disclosure, a method for maintaining candidate cell configuration is provided, the method is performed by a terminal device, and the method includes: receiving updated candidate cell configuration or candidate cell group configuration.

### BRIEF DESCRIPTION OF DRAWINGS

The accompanying drawings described herein are provided to provide a further understanding of the present disclosure and constitute a part of the present disclosure. Illustrative embodiments of the present disclosure and their descriptions are used to explain the present disclosure and do not constitute improper limitations on the present disclosure. In the accompanying drawings:

FIG. 1 is a schematic diagram of a communication system according to an embodiment of the present disclosure.

FIG. 2 is a schematic diagram of a communication system according to an embodiment of the present disclosure.

FIG. 3 is a schematic diagram of a communication system according to an embodiment of the present disclosure.

FIG. 4 is a flowchart of a method of maintaining candidate cell configuration according to an embodiment of the present disclosure.

FIG. 5 is a flowchart of a method of maintaining candidate cell configuration according to an embodiment of the present disclosure.

FIG. 6 is a flowchart of a method of maintaining candidate cell configuration according to an embodiment of the present disclosure.

FIG. 7 is a flowchart of a method of maintaining candidate cell configuration according to an embodiment of the present disclosure.

FIG. 8 is a flowchart of a method of maintaining candidate cell configuration according to an embodiment of the present disclosure.

FIG. 9 is a flowchart of a method of maintaining candidate cell configuration according to an embodiment of the present disclosure.

FIG. 10 is a flowchart of a method of maintaining candidate cell configuration according to an embodiment of the present disclosure.

FIG. 11 is a flowchart of a method of maintaining candidate cell configuration according to an embodiment of the present disclosure.

FIG. 12 is a flowchart of a method of maintaining candidate cell configuration according to an embodiment of the present disclosure.

FIG. 13 is a flowchart of a method of maintaining candidate cell configuration according to an embodiment of the present disclosure.

FIG. 14 is a block diagram of an apparatus of maintaining candidate cell configuration according to an embodiment of the present disclosure.

FIG. 15 is a block diagram of an apparatus of maintaining candidate cell configuration according to an embodiment of the present disclosure.

FIG. 16 is a block diagram of an apparatus of maintaining candidate cell configuration according to an embodiment of the present disclosure.

FIG. 17 is a block diagram of a communication device according to an embodiment of the present disclosure.

### DETAILED DESCRIPTION

The present disclosure will be described in detail below with reference to the accompanying drawings and in conjunction with embodiments. It should be noted that the features in different embodiments of the present disclosure can be combined with each other without conflict.

It should be noted that the terms “first” and “second” in the description, claims of the present disclosure and the above accompanying drawings are used to distinguish similar objects, and are not necessarily used to describe a specific order or sequence.

Firstly, the abbreviations involved in the present disclosure are briefly introduced.

### 1. Dual Connectivity (DC)

In the 5G system, DC architecture is adopted, and terminal devices establish connections with two cell groups: master cell group (MCG) and secondary cell group (SCG).

MCG corresponds to a network side master node (MN); SCG corresponds to a network side secondary node (SN). The MCG includes one primary cell (PCell) and one or more secondary cells (SCells). SCG includes one primary secondary cell (PSCell) and one or more SCells. PCell and PSCell can be collectively named as special cell (SpCell).

### 2. Full Configuration and Delta Configuration

In 4G and 5G systems, the network side provides radio resource control (RRC) configuration message to the terminal device for configuring air interface communication of the terminal device. The RRC configuration message can be configured in the following two ways:

Full configuration: When a new RRC configuration message with full configuration mode is received, current wireless configuration (such as exclusive wireless configuration and general wireless configuration) is cleared, and then the configuration in the RRC configuration message with full configuration mode is applied.

Delta configuration: When a new RRC configuration message with delta configuration mode is received, the configuration in the RRC configuration message with delta configuration mode is applied on the basis of the current wireless configuration. The “current wireless configuration” is considered as a “reference configuration” of the “delta configuration”. (For example, a value of “domain −1” in the current wireless configuration is “1” and a value of “domain −1” is “1”, and a value of “domain-1” in the delta configuration is “2”. After receiving the delta configuration, set the value of “domain-1” to “2” and keep the value of “domain −2” to “1”).

### 3. Mobility Process Based on Conditional Triggering

In the 5G system, the terminal device can be based on a “pre-configured condition” of the network and a “pre-configured candidate cell” corresponding to the condition: when the terminal device meets the “pre-configured condition” (such as a specific measurement event), the terminal device will change the serving cell to the “pre-configured candidate cell”. The “mobility process based on conditional triggering” includes at least one of:
conditional handover (CHO);
conditional PSCell addition (CPA); or
conditional PSCell change (CPC).

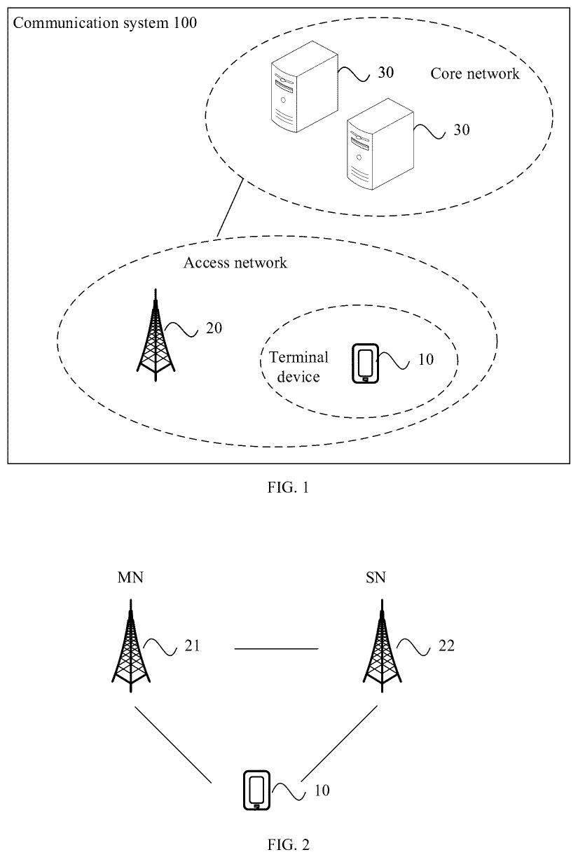

Please refer to FIG. 1, which shows a schematic diagram of a communication system 100 according to an embodiment of the present disclosure. The communication system 100 may include a terminal device 10, an access network device 20 and a core network device 30.

The terminal device 10 may refer to a user equipment (UE), an access terminal, a subscriber unit, a subscriber station, a mobile, a mobile station (MS), a remote station, a remote terminal, a mobile device, a wireless communication device, a user agent or a user apparatus. In some examples, the terminal device 10 may further be a cellular phone, a cordless phone, a session initiation protocol (SIP) phone, a wireless local loop (WLL) station, a personal digital assistant (PDA), a handheld device with wireless communication function, a computing device or other processing devices connected to a wireless modem, a vehicle-mounted device, a wearable device, a terminal device in the 5th Generation System (5GS) or a terminal device in future evolved public land mobile network (PLMN), etc., which are not limited by the embodiments of the present disclosure. For the convenience of description, the above-mentioned devices are collectively named as terminal devices. The number of terminal devices 10 is usually multiple, and one or more terminal devices 10 can be distributed in the cell managed by each access network device 20.

The access network device 20 is a device deployed in an access network to provide a wireless communication function for the terminal device 10. The access network device 20 may include various forms of macro base stations, micro base stations, relay stations, access points and the like. In systems with different wireless access technologies, the names of devices with access network functions may be different, for example, in 5G NR systems, they are named as gNodeB or gNB. With the evolution of communication technology, the name “access network device” may change. For convenience of description, in the embodiments of the present disclosure, the apparatuses that provide wireless communication function for terminal device 10 are collectively named as access network devices. In some examples, a communication relationship can be established between the terminal device 10 and the core network device 30 through the access network device 20. For example, in the long term evolution (LTE) system, the access network device 20 may be an evolved universal terrestrial radio access network (EUTRAN) or one or more eNBs in the EUTRAN. In the 5G NR system, the access network device 20 may be a radio access network (RAN) or one or more gNBs in the RAN.

The core network device 30 is a device deployed in the core network, and its functions are mainly to provide user connection, user management and service bearing, as a bearing network to provide an interface to external networks. For example, the core network device in the 5G NR system may include an access and mobility management function (AMF) network element, a user plane function (UPF) network element, a session management function (SMF) network element, an authentication server function (AUSF) network element, a ProSe anchor function (PAnF) network element, a ProSe key management function (PKMF) network element, etc.

In an example, the access network device 20 and the core network device 30 communicate with each other through some air interface technology, such as an NG interface in the 5G NR system. The access network device 20 and the terminal device 10 communicate with each other through some air interface technology, such as Uu interface.

The “5G NR system” in the embodiments of the present disclosure can also be named as 5G system or NR system, and those skilled in the art can understand its meaning. The technical solution described in the embodiments of the present disclosure can be applied to 5G NR systems, as well as any wireless communication system, such as subsequent evolution systems of 5G NR systems, B5G, 6G, etc.

The technical solution of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of NR system, an LTE based access to Unlicensed spectrum (LTE-U) system, an NR-U system, a universal mobile telecommunication system (UMTS), a worldwide interoperability for microwave access (WiMAX) communication system, a wireless local area networks (WLAN), a wireless fidelity (WiFi), a next generation communication system or other communication systems.

Dual connectivity (DC) is a generalization of multi-RAT dual connectivity (MR-DC). As shown in FIG. 2, a terminal device 10 supporting multi-transmission connects two access network devices (two network nodes), a network node is MCG, i.e., MN 21, and the other network node is SCG, i.e., SN 22. MN and SN are connected via a network interface, and at least MN is connected to a core network.

Terminal devices that support multiple sending and receiving can be configured with DC. The terminal device enters a DC state, and the terminal device is connected to two access network devices at the same time, one of which plays the role of the MN and the other plays the role of the secondary access network device SN. At present, the multi-wireless access of MR-DC usually means that the terminal device is connected with a 4G long term evolution (LTE) access network device and a 5G new radio (NR) access network device at the same time, or two 5G NR access network devices at the same time.

In some examples, as shown in FIG. 3, the terminal device 10 establishes a connection with the MN 21 and the SN 22, and provides a candidate cell/candidate cell group for the terminal device. The network side can send activation signaling to the terminal device to activate a candidate cell/candidate cell group, so that the terminal device can change a serving cell to an activated candidate cell/candidate cell group. Or the terminal device, when the pre-configuration condition is met, changes the serving cell to a candidate cell/candidate cell group corresponding to the pre-configuration condition.

The MN accessed by the terminal device is named as serving MN, and the SN is named as serving SN. FIG. 3 only takes two candidate cell groups as an example. One candidate cell group whose cell type is MCG can be named as candidate MN, and the other candidate cell group whose cell type is SCG can be named as candidate SN. Then an update process provided by the embodiments of the present disclosure can be initiated between the serving MN and the serving SN, between the serving MN and the candidate MN, between the serving MN and the candidate SN, between the serving SN and the candidate SN, and between the candidate MN and the candidate SN to update candidate cell configuration or candidate cell group configuration, which is also referred to as candidate cell configuration/candidate cell group configuration, or candidate cell (group) configuration.

FIG. 4 illustrates a flowchart of a method of maintaining candidate cell configuration according to an embodiment of the present disclosure. The method of maintaining the candidate cell configuration may be performed by a first network node. The method includes:
at step 210: initiating an update process on candidate cell configuration or candidate cell group configuration with a second network node.

The first network node is a network node that requests candidate cell (group) configuration. The second network node is a network node that provides candidate cell (group) configuration. For example, the network node is an access network device, which corresponds to a cell or a cell group. In some examples, the first network node/second network node is a network side/network device side mentioned in the embodiment of the present disclosure. The candidate cell configuration/candidate cell group configuration provided by the second network node is configuration information of the candidate cell/candidate cell group where the second network node is located, or the candidate cell configuration/candidate cell group configuration provided by the second network node is configuration information of other candidate cells/candidate cell groups obtained by the second network node.

The first network node includes at least one of: a serving master node, a serving secondary node, or a potential target master node. The second network node includes at least one of: a potential target master node, a potential target secondary node, or a serving secondary node.

In some examples, in the case that the first network node is the serving master node, the second network node includes at least one of a potential target master node, a potential target secondary node and a serving secondary node; in the case that the first network node is a serving secondary node, the second network node includes a potential target secondary node; in the case that the first network node is a potential target master node, the second network node includes a potential target secondary node. That is, the serving MN may request to obtain the candidate cell configuration/candidate cell group configuration of the serving SN, the potential target MN and the potential target SN; the serving SN may request to obtain the candidate cell configuration/candidate cell group configuration of the potential target SN; and the potential target MN may request to acquire the candidate cell configuration/candidate cell group configuration of the potential target SN.

The terminal device accesses the serving master node (e.g., MCG) and the serving secondary node (e.g., SCG) in a dual connectivity mode. That is, the serving master node is an MCG that provides services for the terminal device in the dual connectivity state, and the serving secondary node is the SCG that provides services for the terminal device in the dual connectivity state. The serving master node and the serving secondary node are the network nodes that the terminal device is currently accessing. MCG includes a PCell and one or more SCells. SCG includes a PSCell and one or more SCells. The network device side configures at least one candidate cell/candidate cell group for the terminal device.

The network side provides the terminal device with the candidate cell configuration of at least one candidate cell and/or the candidate cell group configuration of at least one candidate cell group. The potential target master node is a candidate cell whose cell type is a primary cell, or the potential target master node is a candidate cell group whose cell group type is MCG. The potential target secondary node is a candidate cell whose cell type is a primary secondary cell, or the potential target secondary node is a candidate cell group whose cell group type is SCG. The potential target master node and the potential target secondary node are the network nodes corresponding to the candidate cell configuration/candidate cell group configuration. The potential target master node and the potential target secondary node are the network nodes that the terminal device may access in the subsequent selective activation process. For example, when a potential target master node is activated, the terminal device accesses the potential target master node, which is a new serving master node.

For example, a cell type of a candidate cell includes at least one of: Pcell, PSCell, SpCell, SCell, MCG SCell, or SCG SCell. A cell group type of a candidate cell group includes at least one of: MCG, or SCG. For example, for a candidate cell, the cell type of the candidate cell may be one or more; for a candidate cell group, the cell group type of the candidate cell group can be one or more.

For example, before step 210, the terminal device receives the candidate cell configuration/candidate cell group configuration sent by the network device. When the candidate cell configuration/candidate cell group configuration needs to be updated, the first network node and the second network node on the network side initiate the update process on the candidate cell configuration/candidate cell group configuration, and negotiate to update the candidate cell configuration/candidate cell group configuration to obtain updated candidate cell configuration/candidate cell group configuration. The network side sends the updated candidate cell configuration/candidate cell group configuration to the terminal device.

The candidate cell (group) configuration is used for selective activation of the cell process, or for a mobility process based on conditional triggering. The mobility process based on conditional triggering includes at least one of: CHO, CPA or CPC. For example, when the terminal device receives an activation signaling for a certain candidate cell configuration, it changes the serving cell to a candidate cell corresponding to that candidate cell configuration. Or the terminal device, when the terminal device meets a pre-configured condition corresponding to a certain candidate cell configuration, it changes the serving cell to a candidate cell corresponding to that candidate cell configuration.

To sum up, in the method provided by this embodiment, the first network node and the second network node initiate the update process on the candidate cell (group) configuration, and the two network nodes negotiate to update the candidate cell (group) configuration. The network device can provide the latest configuration to the terminal device according to the network environment (such as signal quality and load), and ensure that the updated candidate cell (group) configuration remains consistent among various network nodes.

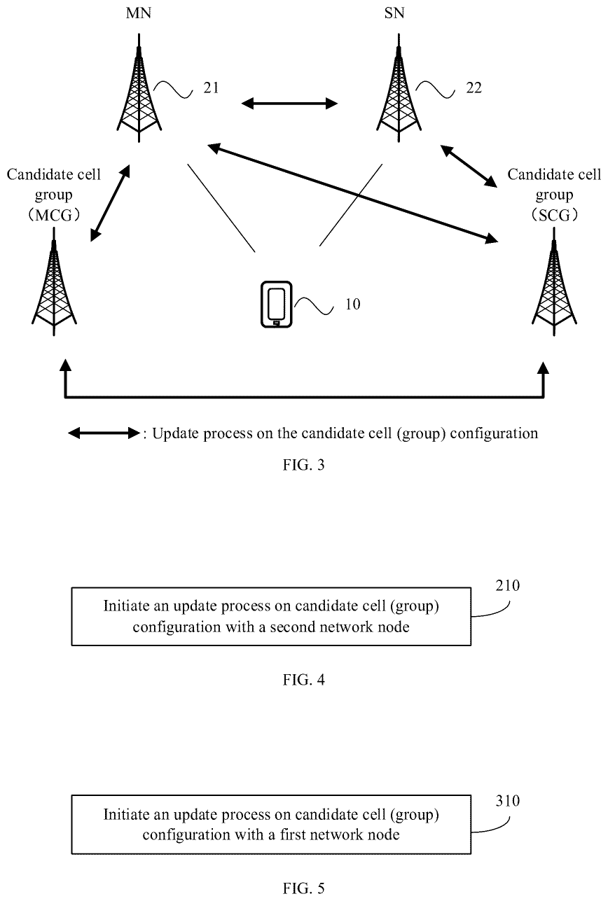

FIG. 5 illustrates a flowchart of a method of maintaining candidate cell configuration according to an embodiment of the present disclosure. The method of maintaining the candidate cell configuration may be performed by a second network node. The method includes:
at step 310: initiating an update process on candidate cell configuration or candidate cell group configuration with a first network node.

The embodiment of the present disclosure provides two ways to initiate the update process.

Way 1: A negotiation process is initiated by the network node that requests the candidate cell configuration/candidate cell group configuration. That is, the first network node sends a first update request message to the second network node, and the first update request message requests to initiate the update process on the candidate cell (group) configuration.

Way 2: A negotiation process is initiated by the network node that provides the candidate cell configuration/candidate cell group configuration. That is, the second network node sends a second update request message to the first network node, and the second update request message requests to initiate the update process on the candidate cell (group) configuration.

To sum up, in the method provided by this embodiment, the first network node and the second network node initiate the update process on the candidate cell (group) configuration, and the two network nodes negotiate to update the candidate cell (group) configuration. The network device can provide the latest configuration to the terminal device according to the network environment (such as signal quality and load), and ensure that the updated candidate cell (group) configuration remains consistent among various network nodes.

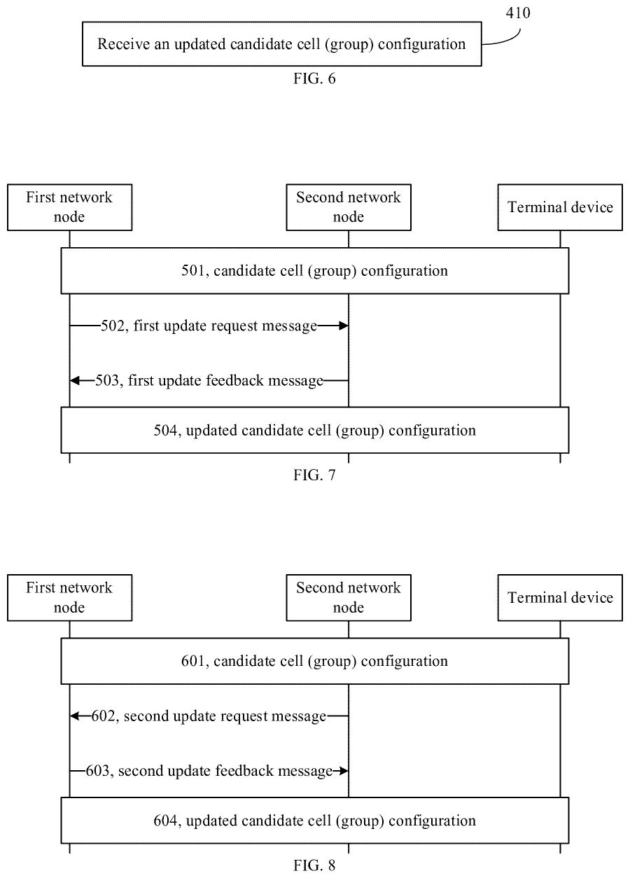

FIG. 6 illustrates a flowchart of a method of maintaining candidate cell configuration according to an embodiment of the present disclosure. The method of maintaining the candidate cell configuration may be performed by a terminal device. The method includes:
at step 410: receiving updated candidate cell configuration or candidate cell group configuration.

For example, the updated candidate cell (group) configuration adopts a delta configuration mode or a full configuration mode. For example, the network device sends the updated candidate cell (group) configuration to the terminal device in the delta configuration mode; or, the network device sends the updated candidate cell (group) configuration to the terminal device in the full configuration mode.

In the case of delta configuration, the terminal device adopts reference configuration of network configuration, or the terminal device adopts reference configuration agreed in a protocol.

For example, when the candidate cell configuration/candidate cell group configuration corresponds to a pre-configuration condition, when the pre-configuration condition is met, the terminal device obtains the updated candidate cell configuration/candidate cell group configuration corresponding to the pre-configuration condition, and changes the serving cell to its corresponding candidate cell/candidate cell group.

The updated candidate cell configuration includes at least one of: a newly added candidate cell, newly added cell configuration of a candidate cell, a current candidate cell, a deleted candidate cell, a changed candidate cell, a changed cell type of a candidate cell, changed cell configuration of a candidate cell, reference configuration corresponding to delta configuration on a condition that the delta configuration is adopted for the candidate cell configuration, or a purpose of a candidate cell.

The updated candidate cell group configuration includes at least one of: a newly added candidate cell group, newly added cell group configuration of a candidate cell group, a current candidate cell group, a deleted candidate cell group, a changed candidate cell group, a changed cell group type of a candidate cell group, changed cell group configuration of a candidate cell group, reference configuration corresponding to delta configuration on a condition that the delta configuration is adopted for the candidate cell group configuration, or a purpose of a candidate cell group.

To sum up, in the method provided by this embodiment, the first network node and the second network node initiate the update process on the candidate cell (group) configuration, and the two network nodes negotiate to update the candidate cell (group) configuration. The network device can provide the latest configuration to the terminal device according to the network environment (such as signal quality and load), and ensure that the terminal side, network side, and multiple network nodes on the network side have a consistent understanding of the updated configuration.

An embodiment of a negotiation process initiated by a network node requesting candidate cell configuration/candidate cell group configuration is given.

FIG. 7 is a flowchart of a method of maintaining candidate cell configuration according to an embodiment of the present disclosure. As shown in FIG. 7, the method may be performed by a first network node, a second network node and a terminal device. The method includes:
at step 501: a network side sends candidate cell (group) configuration to the terminal device.

In some examples, the serving node (serving master node/serving secondary node) on the network side sends candidate cell (group) configuration to the terminal device. For example, the serving node may be a first network node or a second network node, or a network node other than the first network node and the second network node, such as a third network node.

The candidate cell (group) configuration corresponds to a candidate cell/candidate cell group. The candidate cell (group) configuration is used in the subsequent selective activation process, and the network side can activate the candidate cell/candidate cell group through activation signaling, so that the terminal device can change the serving cell and access the activated candidate cell/candidate cell group.

The candidate cell configuration includes configuration information corresponding to at least one candidate cell. The candidate cell configuration includes a candidate cell identifier, a cell type of a candidate cell, cell configuration of a candidate cell, reference configuration corresponding to delta configuration on a condition that the delta configuration is adopted for the candidate cell configuration, and a purpose of a candidate cell (selective activation of a cell or mobility based on conditional triggering).

The candidate cell group configuration includes configuration information corresponding to at least one candidate cell group. The candidate cell group configuration includes a candidate cell group identifier, a cell group type of a candidate cell group, cell group configuration of a candidate cell group, reference configuration corresponding to delta configuration on a condition that the delta configuration is adopted for the candidate cell group configuration, and a purpose of a candidate cell group (selective activation of a cell or mobility based on conditional triggering).

The cell identifier of the candidate cell includes at least one of: a cell global identifier (CGI), a frequency point (e.g., absolute radio frequency channel number (ARFCN)), a physical cell identifier (PCI), or a cell type (e.g., PCell, SpCell, PSCell, SCell, MCG SCell, SCG SCell).

The cell group identifier of the candidate cell group includes at least one of: a cell identifier of a candidate cell included in a candidate cell group (for example, by indicating the cell identifier (such as CGI, frequency plus PCI, or PCI) of a candidate cell (such as a PCell of MCG or a PSCell of SCG) in the candidate cell group, thereby indicating the candidate cell group), a candidate cell group configuration identifier, or a candidate cell group type (such as MCG or SCG).

At step 502: the first network node sends a first update request message to the second network node.

In a case that the first update request message requests to update the candidate cell configuration, the first update request message requests to at least one of: add a new candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell.

In a case that the first update request message requests to update the candidate cell group configuration, the first update request message requests to at least one of: add a new candidate cell group, delete a candidate cell group, change candidate cells designated in a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

The candidate cell is identified by a candidate cell identifier, and the candidate cell identifier includes at least one of: a cell global identifier, a frequency point, a physical cell identifier or a cell type; the candidate cell group is identified by a candidate cell group identifier, and the candidate cell group identifier includes at least one of: a candidate cell identifier of each candidate cell included in the candidate cell group, a candidate cell group configuration identifier, or a candidate cell group type.

The request to change a candidate cell refers to a request to change an original candidate cell in an original candidate cell configuration/candidate cell group configuration to a new candidate cell, e.g., to replace an original candidate cell with a new candidate cell.

When the candidate cell configuration/candidate cell group configuration adopts delta configuration, the reference configuration corresponding to the delta configuration can be indicated as at least one of: reference configuration corresponding to first issued candidate cell (group) configuration; reference configuration corresponding to previously issued candidate cell (group) configuration; merged configuration obtained by merging first issued candidate cell (group) configuration with corresponding reference configuration; merged configuration obtained by merging previously issued candidate cell (group) configuration with corresponding reference configuration; first issued candidate cell (group) configuration; previously issued candidate cell (group) configuration; designated cell (group) configuration; cell configuration of a first cell currently serving, where a cell type of the first cell is the same as a cell type of an updated candidate cell; cell group configuration of a first cell group currently serving, where a cell group type of the first cell group is the same as a cell group type of an updated candidate cell group; cell configuration of a second cell, where a configuration identifier of the second cell is the same as a configuration identifier of an updated candidate cell; cell group configuration of a second cell group, where a configuration identifier of the second cell group is the same as a configuration identifier of the updated candidate cell group; cell configuration of a third cell, where a cell identifier of the third cell is the same as a cell identifier of an updated candidate cell; or cell group configuration of a third cell group, where a cell group identifier of the third cell group is the same as a cell group identifier of the updated candidate cell group.

One reference configuration can be indicated for each candidate cell configuration/candidate cell group configuration, or one reference configuration can be indicated for all current candidate cell configurations/candidate cell group configurations. One reference configuration can further be indicated for a newly added candidate cell/candidate cell group. One reference configuration can further be indicated for a changed added candidate cell/candidate cell group.

At step 503: the second network node sends a first update feedback message to the first network node.

In a case that the first update request message requests to update the candidate cell configuration, the first update feedback message indicates at least one of: a newly added candidate cell, newly added cell configuration of a candidate cell, a current candidate cell, a deleted candidate cell, a changed candidate cell, a changed cell type of a candidate cell, changed cell configuration of a candidate cell, reference configuration corresponding to delta configuration on a condition that the delta configuration is adopted for the candidate cell configuration, or a purpose of a candidate cell.

In a case that the first update request message requests to update the candidate cell group configuration, the first update feedback message indicates at least one of: a newly added candidate cell group, newly added cell group configuration of a candidate cell group, a current candidate cell group, a deleted candidate cell group, a changed candidate cell group, a changed cell group type of a candidate cell group, changed cell group configuration of a candidate cell group, reference configuration corresponding to delta configuration on a condition that the delta configuration is adopted for the candidate cell group configuration, or a purpose of a candidate cell group.

For example, the candidate cell group configuration received by the terminal device in step 501 includes configuration information of candidate cell group 1, candidate cell group 2 and candidate cell group 3.

Then, in step 502, the first update request message sent by the first network node may include: a request to add a new candidate cell group 4, a request to delete candidate cell group 3, a request to change candidate cell group 2 to candidate cell group 5, a request to change a cell group type of candidate cell group 1 from MCG to SCG, and a request to change cell group configuration of candidate cell group 1.

In step 503, the first update feedback message sent by the second network node may include: the newly added candidate cell group 4, the deleted candidate cell group 3, the change of candidate cell group 2 to candidate cell group 5, the change of the cell group type of candidate cell group 1 to SCG, and the change of the cell group configuration of candidate cell group 1. After the update process, the updated candidate cell group configuration includes configuration information for candidate cell group 1, candidate cell group 4, and candidate cell group 5.

At step 504: the network side synchronizes updated candidate cell configuration/candidate cell group configuration with the terminal device.

When the first network node is the serving master node, the first network node synchronizes the updated candidate cell (group) configuration with the terminal device.

When the first network node is not the serving master node, the first network node synchronizes the updated candidate cell (group) configuration with the serving master node, and the serving master node synchronizes the updated candidate cell (group) configuration with the terminal device. Or, when the first network node is a serving secondary node, the first network node synchronizes the updated candidate cell (group) configuration to the terminal device.

The network side sends the updated candidate cell configuration/candidate cell group configuration to the terminal device using either a full configuration or a delta configuration mode. That is, the updated candidate cell (group) configuration adopts a delta configuration mode; or, the updated candidate cell (group) configuration adopts a full configuration mode.

For example, in the case of delta configuration mode, the network device may further send a reference configuration indication to the terminal device, which is used to indicate the reference configuration corresponding to the delta configuration (updated candidate cell (group) configuration). Or, the terminal device can determine the reference configuration corresponding to the delta configuration according to the protocol agreement.

For example, the updated candidate cell (group) configuration adopts an delta configuration mode; reference configuration of the updated candidate cell (group) configuration includes at least one of: reference configuration corresponding to first issued candidate cell (group) configuration; reference configuration corresponding to previously issued candidate cell (group) configuration; merged configuration obtained by merging first issued candidate cell (group) configuration with corresponding reference configuration; merged configuration obtained by merging previously issued candidate cell (group) configuration with corresponding reference configuration; first issued candidate cell (group) configuration; previously issued candidate cell (group) configuration; designated cell (group) configuration; cell configuration of a first cell currently serving, where a cell type of the first cell is the same as a cell type of an updated candidate cell; cell group configuration of a first cell group currently serving, where a cell group type of the first cell group is the same as a cell group type of an updated candidate cell group; cell configuration of a second cell, where a configuration identifier of the second cell is the same as a configuration identifier of an updated candidate cell; cell group configuration of a second cell group, where a configuration identifier of the second cell group is the same as a configuration identifier of the updated candidate cell group; or cell configuration of a third cell, where a cell identifier of the third cell is the same as a cell identifier of an updated candidate cell; or cell group configuration of a third cell group, where a cell group identifier of the third cell group is the same as a cell group identifier of the updated candidate cell group.

That is, the method for the terminal to apply the delta configuration includes any one of the following.

Delta configuration method 1: Take the reference configuration corresponding to the first issued candidate cell (or candidate cell group) configuration as the reference configuration of “the updated candidate cell (or candidate cell group) configuration”. (For example, when the candidate cell group configuration-1 for candidate cell group-1 is provided for the first time, the candidate cell group configuration-1 is delta configuration for a currently serving SCG (or MCG) configuration (i.e., the currently serving SCG (or MCG) configuration is the reference configuration). When updating the configuration of candidate cell group-1 and providing candidate cell group configuration-2, the reference configuration of candidate cell group configuration-1 is taken as the reference configuration for candidate cell group configuration-2).

Delta configuration method 2: Take the reference configuration corresponding to the previously issued candidate cell (or candidate cell group) configuration as the reference configuration of “the updated candidate cell (or candidate cell group) configuration”. (For example, when the candidate cell group configuration-1 for candidate cell group-1 was previously provided, the candidate cell group configuration-1 is delta configuration for a network-specified SCG (or MCG) configuration. When updating the configuration of candidate cell group-1 and providing candidate cell group configuration-2, the reference configuration of candidate cell group configuration-1 is taken as the reference configuration for candidate cell group configuration-2).

Delta configuration method 3: Take the merged configuration obtained by merging the first issued candidate cell (or candidate cell group) configuration with its corresponding reference configuration as the reference configuration of “the updated candidate cell (or candidate cell group) configuration”. (For example, when the candidate cell group configuration-1 for candidate cell group-1 is provided for the first time, the candidate cell group configuration-1 is delta configuration for a currently serving SCG (or MCG) configuration (i.e., the currently serving SCG (or MCG) configuration is the reference configuration). The terminal merges the candidate cell group configuration-1 and its reference configuration into merged configuration-1. When updating the configuration of candidate cell group-1 and providing candidate cell group configuration-2, the merge configuration-1 is taken as the reference configuration for candidate cell group configuration-2).

Delta configuration method 4: Take the merged configuration obtained by merging the previously issued candidate cell (or candidate cell group) configuration with its corresponding reference configuration as the reference configuration of “the updated candidate cell (or candidate cell group) configuration”. (For example, when the candidate cell group configuration-1 for candidate cell group-1 was previously provided, the candidate cell group configuration-1 is delta configuration for a network-specified SCG (or MCG) configuration. The terminal merges the candidate cell group configuration-1 and its reference configuration into merged configuration-1. When updating the configuration of candidate cell group-1 and providing candidate cell group configuration-2, the merge configuration-1 is taken as the reference configuration for candidate cell group configuration-2).

Delta configuration method 5: Take the first issued candidate cell (or candidate cell group) configuration as the reference configuration of “the updated candidate cell (or candidate cell group) configuration”.

Delta configuration method 6: Take the previously issued candidate cell (or candidate cell group) configuration as the reference configuration of “the updated candidate cell (or candidate cell group) configuration”.

Delta configuration method 7: Take the designated cell (group) configuration as the reference configuration of “the updated candidate cell (or candidate cell group) configuration”. For example, the network side configures the designated cell (group) configuration 1 as reference configuration.

Delta configuration method 8: Take the cell configuration of the serving cell with the same cell type as the updated candidate cell configuration as the reference configuration of “the updated candidate cell configuration”; and take the cell group configuration of the serving cell group with the same cell group type as the updated candidate cell group configuration as the reference configuration of “the updated candidate cell group configuration”. For example, if the cell type corresponding to the updated candidate cell configuration is PCell, the cell configuration of the PCell currently serving the terminal is taken as the reference configuration of the updated candidate cell configuration. If the cell group type corresponding to the updated candidate cell group configuration is MCG, the cell group configuration of the MCG currently serving the terminal is taken as the reference configuration of the updated candidate cell group configuration.

Delta configuration method 9: Take the cell configuration with the same configuration identifier as the updated candidate cell configuration as the reference configuration of “the updated candidate cell configuration”; and take the cell group configuration with the same configuration identifier as the updated candidate cell group configuration as the reference configuration of “the updated candidate cell group configuration”. For example, if the configuration identifier corresponding to the updated candidate cell configuration is 1, the cell configuration with the configuration identifier of 1 stored by the terminal device is taken as the reference configuration. If the configuration identifier corresponding to the updated candidate cell group configuration is 2, the cell group configuration with the configuration identifier of 2 stored in the terminal device is taken as the reference configuration.

Delta configuration method 10: Take the cell configuration with the same cell identifier as the updated candidate cell configuration as the reference configuration of “the updated candidate cell configuration”; and take the cell group configuration with the same cell group identifier as the updated candidate cell group configuration as the reference configuration of “the updated candidate cell group configuration”. For example, if the cell identifier corresponding to the updated candidate cell configuration is 1, the cell configuration with the cell identifier of 1 stored by the terminal device is taken as the reference configuration. If the cell identifier corresponding to the updated candidate cell group configuration is 2, the cell group configuration with the cell identifier of 2 stored in the terminal device is taken as the reference configuration.

To sum up, in the method provided in this embodiment, a network node requesting candidate cell (group) configuration initiates an update process on candidate cell (group) configuration to a network node providing candidate cell (group) configuration, and two network nodes negotiate to update the candidate cell (group) configuration. The network device can provide the latest configuration to the terminal device according to the network environment (such as signal quality and load), and ensure that the updated candidate cell (group) configuration remains consistent among various network nodes.

An embodiment of a negotiation process initiated by a network node providing candidate cell (group) configuration is given.

FIG. 8 is a flowchart of a method of maintaining candidate cell configuration according to an embodiment of the present disclosure. As shown in FIG. 8, the method may be performed by a first network node, a second network node and a terminal device. The method includes:
at step 601: a network side sends candidate cell (group) configuration to the terminal device.

For example, step 601 can refer to the related description of step 501.

At step 602: the second network node sends a second update request message to the first network node.

In a case that the second update request message requests to update the candidate cell configuration, the second update request message requests to at least one of: add a new candidate cell, add new cell configuration of a candidate cell, a current candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell.

In a case that the second update request message requests to update the candidate cell group configuration, the second update request message requests to at least one of: add a new candidate cell group, add new cell group configuration of a candidate cell group, a current candidate cell group, delete a candidate cell group, change a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

The candidate cell is identified by a candidate cell identifier, and the candidate cell identifier includes at least one of: a cell global identifier, a frequency point, a physical cell identifier or a cell type; the candidate cell group is identified by a candidate cell group identifier, and the candidate cell group identifier includes at least one of: a candidate cell identifier of each candidate cell included in the candidate cell group, a candidate cell group configuration identifier, or a candidate cell group type.

Changing a candidate cell refers to changing an original candidate cell in an original candidate cell configuration/candidate cell group configuration to a new candidate cell, e.g., to replace an original candidate cell with a new candidate cell.

When the candidate cell configuration/candidate cell group configuration adopts delta configuration, the reference configuration corresponding to the delta configuration can be indicated as at least one of: reference configuration corresponding to first issued candidate cell (group) configuration; reference configuration corresponding to previously issued candidate cell (group) configuration; merged configuration obtained by merging first issued candidate cell (group) configuration with corresponding reference configuration; merged configuration obtained by merging previously issued candidate cell (group) configuration with corresponding reference configuration; first issued candidate cell (group) configuration; previously issued candidate cell (group) configuration; designated cell (group) configuration; cell configuration of a first cell currently serving, where a cell type of the first cell is the same as a cell type of an updated candidate cell; cell group configuration of a first cell group currently serving, where a cell group type of the first cell group is the same as a cell group type of an updated candidate cell group; cell configuration of a second cell, where a configuration identifier of the second cell is the same as a configuration identifier of an updated candidate cell; cell group configuration of a second cell group, where a configuration identifier of the second cell group is the same as a configuration identifier of the updated candidate cell group; or cell configuration of a third cell, where a cell identifier of the third cell is the same as a cell identifier of an updated candidate cell; or cell group configuration of a third cell group, where a cell group identifier of the third cell group is the same as a cell group identifier of the updated candidate cell group.

One reference configuration can be indicated for each candidate cell configuration/candidate cell group configuration, or one reference configuration can be indicated for all current candidate cell configurations/candidate cell group configurations. One reference configuration can further be indicated for a newly added candidate cell/candidate cell group. One reference configuration can further be indicated for a changed added candidate cell/candidate cell group.

At step 603: the first network node sends a second update feedback message to the second network node.

In a case that the second update request message requests to update the candidate cell configuration, the second update feedback message indicates at least one of: acceptance to adding a new candidate cell, acceptance to a current candidate cell, acceptance to deleting a candidate cell, acceptance to changing a candidate cell, acceptance to changing a cell type of a candidate cell, acceptance to changing cell configuration of a candidate cell, rejection to adding a new candidate cell, rejection to deleting a candidate cell, rejection to changing a candidate cell, rejection to changing a cell type of a candidate cell, rejection to changing cell configuration of a candidate cell, reference configuration corresponding to delta configuration on a condition that the delta configuration is adopted for the candidate cell configuration, or a purpose of a candidate cell.

In a case that the second update request message requests to update the candidate cell configuration, the second update feedback message indicates at least one of: acceptance to adding a new candidate cell group, acceptance to a current candidate cell group, acceptance to deleting a candidate cell group, acceptance to changing candidate cells designated in a candidate cell group, acceptance to changing a cell group type of a candidate cell group, acceptance to changing cell group configuration of a candidate cell group, rejection to adding a new candidate cell group, rejection to deleting a candidate cell group, rejection to changing candidate cells designated in a candidate cell group, rejection to changing a cell group type of a candidate cell group, rejection to changing cell group configuration of a candidate cell group, reference configuration corresponding to delta configuration on a condition that the delta configuration is adopted for the candidate cell group configuration, or a purpose of a candidate cell group.

For example, the candidate cell configuration received by the terminal device in step 601 includes configuration information of candidate cell 1, candidate cell 2 and candidate cell 3.

Then, in step 602, the second update request message sent by the second network node may include: adding a new candidate cell 4; deleting a candidate cell 3; changing a candidate cell 2 to candidate cell 5; the current candidate cells are: candidate cell 1, candidate cell 4, and candidate cell 5; changing a cell type of candidate cell 1 from MCG to SCG; and changing cell configuration of candidate cell 1.

In step 603, the second update feedback message sent by the first network node may include: acceptance to adding the candidate cell 4; rejection to deleting the candidate cell 3;acceptance to changing the candidate cell 2 to candidate cell 5; the current candidate cells are: candidate cell 1, candidate cell 3, candidate cell 4 and candidate cell 5; acceptance to changing the cell group type of candidate cell 1 to SCG; acceptance to changing cell configuration of the candidate cell 1. The updated candidate cell configuration obtained after the update process includes configuration information for candidate cell 1, candidate cell 3, candidate cell 4 and candidate cell 5.

At step 604: the network side synchronizes updated candidate cell configuration/candidate cell group configuration with the terminal device.

For example, step 604 can refer to the related description of step 504.

To sum up, in the method provided in this embodiment, a network node providing candidate cell (group) configuration initiates an update process on candidate cell (group) configuration to a network node requesting candidate cell (group) configuration, and two network nodes negotiate to update the candidate cell (group) configuration. The network device can provide the latest configuration to the terminal device according to the network environment (such as signal quality and load), and ensure that the updated candidate cell (group) configuration remains consistent among various network nodes.

An embodiment of a serving master node negotiating with a serving secondary node to update candidate cell (group) configuration is given.

FIG. 9 is a flowchart of a method of maintaining candidate cell configuration according to an embodiment of the present disclosure. As shown in FIG. 9, the method can be executed by a serving master node and a serving secondary node. The method includes:
at step 701: the serving master node and the serving secondary node initiate an update process on candidate cell configuration or candidate cell group configuration.

For example, the serving master node serves as the first network node, and the serving secondary node serves as the second network node.

An update process can be initiated between the serving master node and the serving secondary node to update candidate cell (group) configuration of a candidate cell/candidate cell group corresponding to the serving secondary node.

That is, the cell/cell group corresponding to the serving secondary node can be used as a candidate cell/cell group, and the serving master node can negotiate with the serving secondary node to update the configuration of the candidate cell/cell group. For example, after the candidate cell (cell type is MCG) corresponding to the serving secondary node is activated, the terminal device takes the serving secondary node as the serving master node.

Or, an update process can be initiated between the serving master node and the serving secondary node to update candidate cell (group) configuration of a candidate cell (group) corresponding to a potential target secondary node.

For example, when the serving master node and the serving secondary node initiate an update process regarding a potential target secondary node, the serving secondary node can initiate an update process with the potential target secondary node to negotiate an update to the candidate cell configuration/candidate cell group configuration of the potential target secondary node. After obtaining the updated candidate cell configuration/candidate cell group configuration, the serving secondary node completes the update process with the serving master node based on the updated candidate cell configuration/candidate cell group configuration.

In an implementation, referring to the embodiment shown in FIG. 7, a serving master node sends a first update request message to a serving secondary node. The serving secondary node sends a first update feedback message to the serving master node. The serving master node sends the updated candidate cell configuration/candidate cell group configuration to the terminal device.

In another implementation, referring to the embodiment shown in FIG. 8, the serving secondary node sends a second update request message to the serving master node. The serving master node sends a second update feedback message to the serving secondary node. The serving master node sends the updated candidate cell configuration/candidate cell group configuration to the terminal device.

To sum up, in the method provided in this embodiment, the serving master node and the serving secondary node can initiate the update process on the candidate cell (group) configuration, and negotiate to update the candidate cell (group) configuration. The network device can provide the latest configuration to the terminal device according to the network environment (such as signal quality and load), and ensure that the updated candidate cell (group) configuration remains consistent among various network nodes.

An embodiment of a serving master node negotiating with a potential target master node to update candidate cell (group) configuration is given.

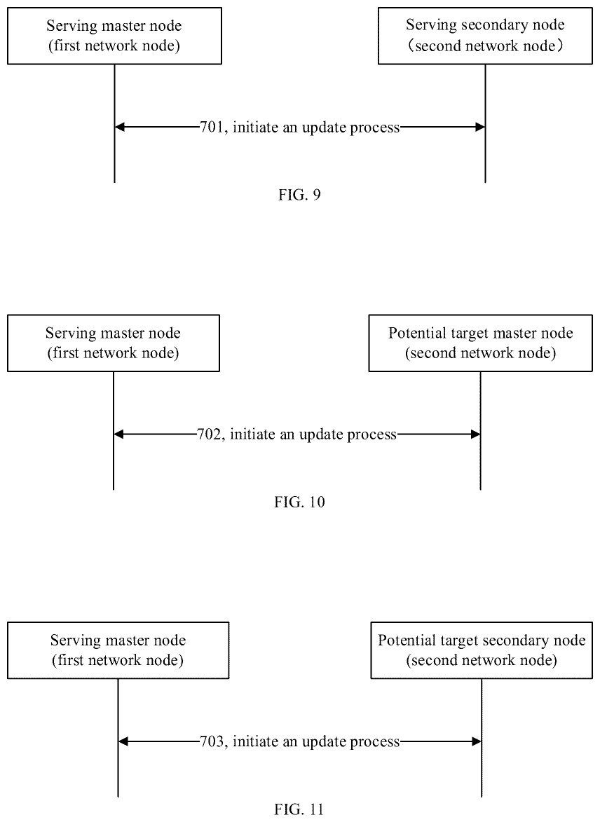

FIG. 10 is a flowchart of a method of maintaining candidate cell configuration according to an embodiment of the present disclosure. As shown in FIG. 10, the method can be executed by a serving master node and a potential target master node. The method includes:
at step 702: the serving master node and the potential target master node initiate an update process on candidate cell configuration or candidate cell group configuration.

For example, the serving master node serves as the first network node, and the potential target master node serves as the second network node. The potential target master node can be any candidate cell with a cell type of primary cell or any candidate cell group with a cell group type of MCG.

An update process can be initiated between the serving master node and the potential target master node to update candidate cell (group) configuration of a candidate cell (group) corresponding to a potential target master node.

Or, an update process can be initiated between the serving master node and the potential target master node to update candidate cell (group) configuration of a candidate cell (group) corresponding to a potential target secondary node.

For example, when the serving master node and the potential target master node initiate an update process regarding a potential target secondary node, the potential target master node can initiate an update process with the potential target secondary node to negotiate an update to the candidate cell configuration/candidate cell group configuration of the potential target secondary node. After obtaining the updated candidate cell configuration/candidate cell group configuration, the potential target master node completes the update process with the serving master node based on the updated candidate cell configuration/candidate cell group configuration.

In an implementation, referring to the embodiment shown in FIG. 7, a serving master node sends a first update request message to a potential target master node. The potential target master node sends a first update feedback message to the serving master node. The serving master node sends the updated candidate cell configuration/candidate cell group configuration to the terminal device.

In another implementation, referring to the embodiment shown in FIG. 8, the potential target master node sends a second update request message to the serving master node. The serving master node sends a second update feedback message to the potential target master node. The serving master node sends the updated candidate cell configuration/candidate cell group configuration to the terminal device.

To sum up, in the method provided in this embodiment, the serving master node and the potential target master node can initiate the update process on the candidate cell (group) configuration, and negotiate to update the candidate cell (group) configuration. The network device can provide the latest configuration to the terminal device according to the network environment (such as signal quality and load), and ensure that the updated candidate cell (group) configuration remains consistent among various network nodes.

An embodiment of a serving master node negotiating with a potential target secondary node to update candidate cell (group) configuration is given.

FIG. 11 is a flowchart of a method of maintaining candidate cell configuration according to an embodiment of the present disclosure. As shown in FIG. 11, the method can be executed by a serving master node and a potential target secondary node. The method includes:
at step 703: the serving master node and the potential target secondary node initiate an update process on candidate cell configuration or candidate cell group configuration.

For example, the serving master node serves as the first network node, and the potential target secondary node serves as the second network node. The potential target secondary node can be any candidate cell with a cell type of primary and secondary cell or any candidate cell group with a cell group type of SCG.

An update process can be initiated between the serving master node and the potential target secondary node to update candidate cell (group) configuration of a candidate cell (group) corresponding to a potential target secondary node.

In an implementation, referring to the embodiment shown in FIG. 7, a serving master node sends a first update request message to a potential target secondary node. The potential target secondary node sends a first update feedback message to the serving master node. The serving master node sends the updated candidate cell configuration/candidate cell group configuration to the terminal device.

In another implementation, referring to the embodiment shown in FIG. 8, the potential target secondary node sends a second update request message to the serving master node. The serving master node sends a second update feedback message to the potential target secondary node. The serving master node sends the updated candidate cell configuration/candidate cell group configuration to the terminal device.

To sum up, in the method provided in this embodiment, the serving master node and the potential target secondary node can initiate the update process on the candidate cell (group) configuration, and negotiate to update the candidate cell (group) configuration. The network device can provide the latest configuration to the terminal device according to the network environment (such as signal quality and load), and ensure that the updated candidate cell (group) configuration remains consistent among various network nodes.

An embodiment of a serving secondary node negotiating with a potential target secondary node to update candidate cell (group) configuration is given.

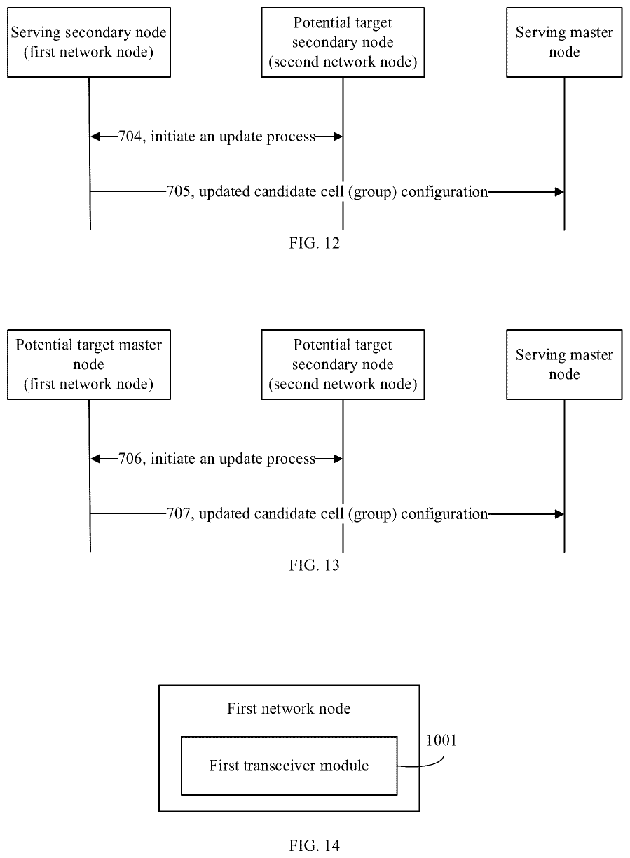

FIG. 12 is a flowchart of a method of maintaining candidate cell configuration according to an embodiment of the present disclosure. As shown in FIG. 12, the method can be executed by a serving secondary node, a potential target secondary node and a serving master node. The method includes:
at step 704: the serving secondary node and the potential target secondary node initiate an update process on candidate cell configuration or candidate cell group configuration.

For example, the serving secondary node serves as the first network node, and the potential target secondary node serves as the second network node. The potential target secondary node can be any candidate cell with a cell type of primary and secondary cell or any candidate cell group with a cell group type of SCG.

An update process can be initiated between the serving secondary node and the potential target secondary node to update a candidate cell (group) configuration of a candidate cell (group) corresponding to a potential target secondary node.

In an implementation, referring to the embodiment shown in FIG. 7, a serving secondary node sends a first update request message to a potential target secondary node. The potential target secondary node sends a first update feedback message to the serving secondary node. The serving secondary node sends the updated candidate cell configuration/candidate cell group configuration to the terminal device.

In another implementation, referring to the embodiment shown in FIG. 8, the potential target secondary node sends a second update request message to the serving secondary node. The serving secondary node sends a second update feedback message to the potential target secondary node. The serving secondary node sends the updated candidate cell configuration/candidate cell group configuration to the terminal device.

At step 705: after the update process is finished, the serving secondary node sends the updated candidate cell configuration or the updated candidate cell group configuration to the serving master node.

The serving master node sends the updated candidate cell (group) configuration to the terminal device.

That is, when the first network node includes the serving secondary node, the second network node includes the potential target secondary node, and the first network node sends a first update request message to the second network node, the first network node sends updated candidate cell configuration or candidate cell group configuration to the serving master node.

To sum up, in the method provided in this embodiment, the serving secondary node and the potential target secondary node can initiate the update process on the candidate cell (group) configuration, and negotiate to update the candidate cell (group) configuration. After the update process is finished, the serving secondary node reports the updated candidate cell configuration/candidate cell group configuration to the serving master node, so that the network device can provide the latest configuration to the terminal device according to the network environment (such as signal quality and load), and ensure that the updated candidate cell (group) configuration remains consistent among various network nodes.

An embodiment of a potential target master node negotiating with a potential target secondary node to update candidate cell (group) configuration is given.

FIG. 13 is a flowchart of a method of maintaining candidate cell configuration according to an embodiment of the present disclosure. As shown in FIG. 13, the method can be executed by a potential target master node, a potential target secondary node and a serving master node. The method includes:
at step 706: the potential target master node and the potential target secondary node initiate an update process on candidate cell configuration or candidate cell group configuration.

For example, the potential target master node serves as the first network node, and the potential target secondary node serves as the second network node. The potential target master node can be any candidate cell with a cell type of primary cell or any candidate cell group with a cell group type of MCG. The potential target secondary node can be any candidate cell with a cell type of primary and secondary cell or any candidate cell group with a cell group type of SCG.

An update process can be initiated between the potential target master node and the potential target secondary node to update candidate cell (group) configuration of a candidate cell (group) corresponding to a potential target secondary node.

In an implementation, referring to the embodiment shown in FIG. 7, a potential target master node sends a first update request message to a potential target secondary node. The potential target secondary node sends a first update feedback message to the potential target master node. The potential target master node sends the updated candidate cell configuration/candidate cell group configuration to the terminal device.

In another implementation, referring to the embodiment shown in FIG. 8, the potential target secondary node sends a second update request message to the potential target master node. The potential target master node sends a second update feedback message to the potential target secondary node. The potential target master node sends the updated candidate cell configuration/candidate cell group configuration to the terminal device.

At step 707: after the update process is finished, the potential target master node sends the updated candidate cell configuration or the updated candidate cell group configuration to the serving master node.

The serving master node sends the updated candidate cell (group) configuration to the terminal device.

That is, when the first network node includes the potential target master node, the second network node includes the potential target secondary node, and the first network node sends a first update request message to the second network node, the first network node sends updated candidate cell configuration or candidate cell group configuration to the serving master node.

Or, when the first network node includes the potential target master node, the second network node includes the potential target secondary node, and the second network node sends a second update request message to the first network node, the updated candidate cell (group) configuration is sent to the serving master node.

To sum up, in the method provided in this embodiment, the potential target primary node and the potential target secondary node can initiate the update process on the candidate cell (group) configuration, and negotiate to update the candidate cell (group) configuration. After the update process is finished, the potential target primary node reports the updated candidate cell configuration/candidate cell group configuration to the serving master node, so that the network device can provide the latest configuration to the terminal device according to the network environment (such as signal quality and load), and ensure that the updated candidate cell (group) configuration remains consistent among various network nodes.

FIG. 14 shows a block diagram of an apparatus for maintaining candidate cell configuration according to an embodiment of the present disclosure, which is configured to implement a first network node, and the apparatus includes:
a first transceiver module 1001, configured to initiate an update process on candidate cell configuration or candidate cell group configuration with a second network node;
where the first network node requests the candidate cell (group) configuration, and the second network node provides the candidate cell (group) configuration.

In an implementation of this embodiment, the first transceiver module 1001 is configured to send a first update request message to the second network node, where the first update request message requests to initiate the update process on the candidate cell (group) configuration.

In an implementation of this embodiment, in a case that the first update request message requests to update the candidate cell configuration, the first update request message requests to at least one of: add a new candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell; and

in a case that the first update request message requests to update the candidate cell group configuration, the first update request message requests to at least one of: add a new candidate cell group, delete a candidate cell group, change candidate cells designated in a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

In an implementation of this embodiment of first transceiver module 1001 is configured to receive a first update feedback message sent by the second network node.

In an implementation of this embodiment, in a case that the first update request message requests to update the candidate cell configuration, the first update feedback message indicates at least one of: a newly added candidate cell, newly added cell configuration of a candidate cell, a current candidate cell, a deleted candidate cell, a changed candidate cell, a changed cell type of a candidate cell, changed cell configuration of a candidate cell, reference configuration corresponding to delta configuration on a condition that the delta configuration is adopted for the candidate cell configuration, or a purpose of a candidate cell; and
in a case that the first update request message requests to update the candidate cell group configuration, the first update feedback message indicates at least one of: a newly added candidate cell group, newly added cell group configuration of a candidate cell group, a current candidate cell group, a deleted candidate cell group, a changed candidate cell group, a changed cell group type of a candidate cell group, changed cell group configuration of a candidate cell group, reference configuration corresponding to delta configuration on a condition that the delta configuration is adopted for the candidate cell group configuration, or a purpose of a candidate cell group.

In an implementation of this embodiment, the first transceiver module 1001 is configured to receive a second update request message sent by the second network node, where the second update request message requests to initiate the update process on the candidate cell (group) configuration.

In an implementation of this embodiment, in a case that the second update request message requests to update the candidate cell configuration, the second update request message requests to at least one of: add a new candidate cell, add new cell configuration of a candidate cell, a current candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell; and
in a case that the second update request message requests to update the candidate cell group configuration, the second update request message requests to at least one of: add a new candidate cell group, add new cell group configuration of a candidate cell group, a current candidate cell group, delete a candidate cell group, change a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

In an implementation of this embodiment, the first transceiver module 1001 is configured to send a second update feedback message to the second network node.

In an implementation of this embodiment, in a case that the second update request message requests to update the candidate cell configuration, the second update feedback message indicates at least one of: acceptance to adding a new candidate cell, acceptance to a current candidate cell, acceptance to deleting a candidate cell, acceptance to changing a candidate cell, acceptance to changing a cell type of a candidate cell, acceptance to changing cell configuration of a candidate cell, rejection to adding a new candidate cell, rejection to deleting a candidate cell, rejection to changing a candidate cell, rejection to changing a cell type of a candidate cell, rejection to changing cell configuration of a candidate cell, reference configuration corresponding to delta configuration on a condition that the delta configuration is adopted for the candidate cell configuration, or a purpose of a candidate cell; and
in a case that the second update request message requests to update the candidate cell group configuration, the second update feedback message indicates at least one of: acceptance to adding a new candidate cell group, acceptance to a current candidate cell group, acceptance to deleting a candidate cell group, acceptance to changing candidate cells designated in a candidate cell group, acceptance to changing a cell group type of a candidate cell group, acceptance to changing cell group configuration of a candidate cell group, rejection to adding a new candidate cell group, rejection to deleting a candidate cell group, rejection to changing candidate cells designated in a candidate cell group, rejection to changing a cell group type of a candidate cell group, rejection to changing cell group configuration of a candidate cell group, reference configuration corresponding to delta configuration on a condition that the delta configuration is adopted for the candidate cell group configuration, or a purpose of a candidate cell group.

In an implementation of this embodiment, the candidate cell is identified by a candidate cell identifier, and the candidate cell identifier includes at least one of: a cell global identifier, a frequency point, a physical cell identifier or a cell type;
the candidate cell group is identified by a candidate cell group identifier, and the candidate cell group identifier includes at least one of: a candidate cell identifier of each candidate cell included in the candidate cell group, a candidate cell group configuration identifier, or a candidate cell group type.

In an implementation of this embodiment, the apparatus is configured to implement the first network node, which includes at least one of:
a serving master node, a serving secondary node, or a potential target master node.

In an implementation of this embodiment, the second network node includes at least one of:
a potential target master node, a potential target secondary node, or a serving secondary node.

In an implementation of this embodiment, in a case that the first network node includes the serving secondary node, the second network node includes the potential target secondary node, and the first network node sends a first update request message to the second network node, updated candidate cell configuration or candidate cell group configuration is sent to the serving master node;
in a case that the first network node includes the potential target master node, the second network node includes the potential target secondary node, and the first network node sends the first update request message to the second network node, the updated candidate cell (group) configuration is sent to the serving master node; and
in a case that the first network node includes the potential target master node, the second network node includes the potential target secondary node, and the second network node sends a second update request message to the first network node, the updated candidate cell (group) configuration is sent to the serving master node.

In an implementation of this embodiment, the apparatus is configured to implement the serving master node;
the first transceiver module 1001 is configured to send updated candidate cell configuration or candidate cell group configuration to a terminal device.

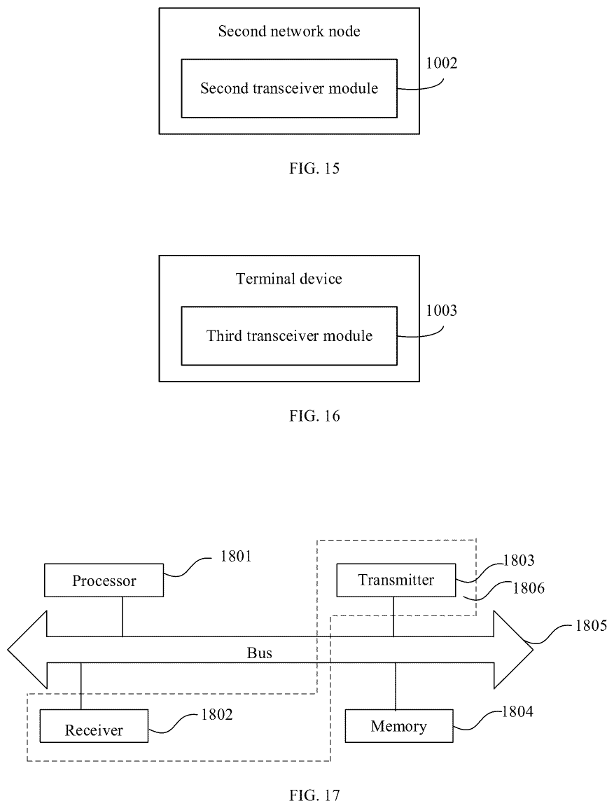

FIG. 15 shows a block diagram of an apparatus for maintaining candidate cell configuration according to an embodiment of the present disclosure, which is configured to implement a second network node, and the apparatus includes:
a second transceiver module 1002, configured to initiate an update process on candidate cell configuration or candidate cell group configuration with a first network node;
where the first network node requests the candidate cell (group) configuration, and the second network node provides the candidate cell (group) configuration.

In an implementation of this embodiment, the second transceiver module 1002 is configured to receive a first update request message sent by the first network node, where the first update request message requests to initiate the update process on the candidate cell (group) configuration.

In an implementation of this embodiment, in a case that the first update request message requests to update the candidate cell configuration, the first update request message requests to at least one of: add a new candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell; and
in a case that the first update request message requests to update the candidate cell group configuration, the first update request message requests to at least one of: add a new candidate cell group, delete a candidate cell group, change candidate cells designated in a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

In an implementation of this embodiment, the second transceiver module 1002 is configured to send a first update feedback message to the first network node.

In an implementation of this embodiment, in a case that the first update request message requests to update the candidate cell configuration, the first update feedback message indicates at least one of: a newly added candidate cell, newly added cell configuration of a candidate cell, a current candidate cell, a deleted candidate cell, a changed candidate cell, a changed cell type of a candidate cell, changed cell configuration of a candidate cell, reference configuration corresponding to delta configuration on a condition that the delta configuration is adopted for the candidate cell configuration, or a purpose of a candidate cell; and
in a case that the first update request message requests to update the candidate cell group configuration, the first update feedback message indicates at least one of: a newly added candidate cell group, newly added cell group configuration of a candidate cell group, a current candidate cell group, a deleted candidate cell group, a changed candidate cell group, a changed cell group type of a candidate cell group, changed cell group configuration of a candidate cell group, reference configuration corresponding to delta configuration on a condition that the delta configuration is adopted for the candidate cell group configuration, or a purpose of a candidate cell group.

In an implementation of this embodiment, the second transceiver module 1002 is configured to send a second update request message to the first network node, where the second update request message requests to initiate the update process on the candidate cell (group) configuration.

In an implementation of this embodiment, in a case that the second update request message requests to update the candidate cell configuration, the second update request message requests to at least one of: add a new candidate cell, add new cell configuration of a candidate cell, a current candidate cell, delete a candidate cell, change a candidate cell, change a cell type of a candidate cell, change cell configuration of a candidate cell, reference configuration corresponding to delta configuration on a condition that the delta configuration is adopted for the candidate cell configuration, or a purpose of a candidate cell; and
in a case that the second update request message requests to update the candidate cell group configuration, the second update request message requests to at least one of: add a new candidate cell group, add new cell group configuration of a candidate cell group, a current candidate cell group, delete a candidate cell group, change a candidate cell group, change a cell group type of a candidate cell group, change cell group configuration of a candidate cell group, reference configuration corresponding to delta configuration on a condition that the delta configuration is adopted for the candidate cell group configuration, or a purpose of a candidate cell group.

In an implementation of this embodiment, the second transceiver module 1002 is configured to receive a second update feedback message sent by the first network node.

In an implementation of this embodiment, in a case that the second update request message requests to update the candidate cell configuration, the second update feedback message indicates at least one of: acceptance to adding a new candidate cell, acceptance to a current candidate cell, acceptance to deleting a candidate cell, acceptance to changing a candidate cell, acceptance to changing a cell type of a candidate cell, acceptance to changing cell configuration of a candidate cell, rejection to adding a new candidate cell, rejection to deleting a candidate cell, rejection to changing a candidate cell, rejection to changing a cell type of a candidate cell, rejection to changing cell configuration of a candidate cell, reference configuration corresponding to delta configuration on a condition that the delta configuration is adopted for the candidate cell configuration, or a purpose of a candidate cell; and
in a case that the second update request message requests to update the candidate cell group configuration, the second update feedback message indicates at least one of: acceptance to adding a new candidate cell group, acceptance to a current candidate cell group, acceptance to deleting a candidate cell group, acceptance to changing candidate cells designated in a candidate cell group, acceptance to changing a cell group type of a candidate cell group, acceptance to changing cell group configuration of a candidate cell group, rejection to adding a new candidate cell group, rejection to deleting a candidate cell group, rejection to changing candidate cells designated in a candidate cell group, rejection to changing a cell group type of a candidate cell group, rejection to changing cell group configuration of a candidate cell group, reference configuration corresponding to delta configuration on a condition that the delta configuration is adopted for the candidate cell group configuration, or a purpose of a candidate cell group.

In an implementation of this embodiment, the candidate cell is identified by a candidate cell identifier, and the candidate cell identifier includes at least one of: a cell global identifier, a frequency point, a physical cell identifier or a cell type;
the candidate cell group is identified by a candidate cell group identifier, and the candidate cell group identifier includes at least one of: a candidate cell identifier of each candidate cell included in the candidate cell group, a candidate cell group configuration identifier, or a candidate cell group type.

In an implementation of this embodiment, the first network node includes at least one of:
a serving master node, a serving secondary node, or a potential target master node.

In an implementation of this embodiment, the apparatus is configured to implement the second network node, which includes at least one of:
a potential target master node, a potential target secondary node, or a serving secondary node.

FIG. 16 shows a block diagram of an apparatus for maintaining a certain candidate cell configuration according to an embodiment of the present disclosure, which is configured to implement a terminal device, and the apparatus includes:
a third transceiver module 1003, configured to receive updated candidate cell configuration or candidate cell group configuration.

In an implementation of this embodiment, the updated candidate cell (group) configuration adopts a delta configuration mode;
or, the updated candidate cell (group) configuration adopts a full configuration mode.

In an implementation of this embodiment, the updated candidate cell (group) configuration adopts a delta configuration mode;
the reference configuration of the updated candidate cell (group) configuration includes at least one of:
reference configuration corresponding to first issued candidate cell (group) configuration;
reference configuration corresponding to previously issued candidate cell (group) configuration;
merged configuration obtained by merging first issued candidate cell (group) configuration with corresponding reference configuration;
merged configuration obtained by merging previously issued candidate cell (group) configuration with corresponding reference configuration;
first issued candidate cell (group) configuration;
previously issued candidate cell (group) configuration;
designated cell configuration or cell group configuration;
cell configuration of a first cell currently serving, where a cell type of the first cell is the same as a cell type of an updated candidate cell;
cell group configuration of a first cell group currently serving, where a cell group type of the first cell group is the same as a cell group type of an updated candidate cell group;
cell configuration of a second cell, where a configuration identifier of the second cell is the same as a configuration identifier of an updated candidate cell;
cell group configuration of a second cell group, where a configuration identifier of the second cell group is the same as a configuration identifier of the updated candidate cell group; or
cell configuration of a third cell, where a cell identifier of the third cell is the same as a cell identifier of an updated candidate cell; or,
cell group configuration of a third cell group, where a cell group identifier of the third cell group is the same as a cell group identifier of the updated candidate cell group.

It should be noted that when the apparatus provided in the above embodiment realizes its functions, it only takes the division of the above-mentioned functional modules as an example. In practical application, the above-mentioned function allocation can be completed by different functional modules according to actual needs, that is, the content structure of the apparatus is divided into different functional modules to complete all or part of the above- mentioned functions.

Regarding to the apparatus in the above embodiment, a specific way in which each module performs operations has been described in detail in the embodiments relating to the method, and will not be described in detail here.

FIG. 17 shows a schematic structure of a communication device (terminal device or network device) according to an embodiment of the present disclosure. The communication device may include a processor 1801, a receiver 1802, a transmitter 1803, a memory 1804 and a bus 1805.

The processor 1801 includes one or more processing cores, and the processor 1801 executes various functional applications and transmits data by running software programs and modules.

The receiver 1802 and the transmitter 1803 can be implemented as a transceiver 1806, which can be a communication chip.

The memory 1804 is connected to the processor 1801 through a bus 1805.

The memory 1804 can be configured to store a computer program, and the processor 1801 is configured to execute the computer program, so as to realize the method of at least one of the first network node side or the second network node side or the terminal device side in the above method embodiment.

In addition, the memory 1804 can be realized by any type of volatile or non-volatile memory device or their combination, including but not limited to: random-access memory (RAM) and read-only memory (ROM), erasable programmable read-only memory (EPROM), electrically erasable programmable read-only memory (EEPROM), flash memory or other solid-state storage technologies, compact disc read-only memory (CD-ROM), high-density digital video disc (DVD) or other optical storage, magnetic tape cassette, magnetic tape, magnetic disk storage or other magnetic storage devices.

When the communication device is implemented as a network device, the processor and transceiver involved in the embodiments of the present disclosure can perform the steps performed by the first network node in any of the methods shown in FIG. 4 to FIG. 13, which are not repeated here.

In an implementation, when the communication device is implemented as a network device,
the transceiver is configured to initiate an update process on candidate cell (group) configuration with a second network node;
where the network device requests the candidate cell (group) configuration, and the second network node provides the candidate cell (group) configuration.

When the communication device is implemented as a network device, the processor and transceiver involved in the embodiments of the present disclosure can perform the steps performed by the second network node in any of the methods shown in FIG. 4 to FIG. 13, which are not repeated here.
the transceiver is configured to initiate an update process on candidate cell (group) configuration with a first network node;
where the first network node requests the candidate cell (group) configuration, and the network device provides the candidate cell (group) configuration.

When the communication device is implemented as a terminal device, the processor and transceiver involved in the embodiments of the present disclosure can perform the steps performed by the terminal device in any of the methods shown in FIG. 4 to FIG. 13, which are not repeated here.

The transceiver is configured to receive updated candidate cell configuration or candidate cell group configuration.

Embodiments of the present disclosure further provide a computer-readable storage medium, which stores a computer program for execution by a processor of a computer device to implement the method on at least one device side of the core network device side, the remote terminal device side, or the relay terminal side in the above method embodiments.

In some examples, the computer-readable storage medium may include read-only memory (ROM), random-access memory (RAM), solid state drives (SSD), optical disks, etc. The random access memory can include resistance random access memory (ReRAM) and dynamic random access memory (DRAM).

Embodiments of the present disclosure further provide a chip, which includes a programmable logic circuit and/or program instructions, and when the chip runs on the terminal device, it is configured to implement the method on at least one device side of the core network device side, remote terminal device side, or relay terminal side in the above method embodiments.

Embodiments of the present disclosure further provide a computer program product or computer program, which includes computer instructions stored in a computer-readable storage medium, and a processor of a terminal device reads and executes the computer instructions from the computer-readable storage medium, so as to realize the method of at least one of the core network device side, the remote terminal device side or the relay terminal side in the above method embodiments.

Through the description of the above embodiments, those skilled in the art can clearly understand that the method according to the above embodiments can be realized by means of software and necessary general hardware platform, and of course it can also be realized by hardware, but in many cases the former is a better embodiment. Based on this understanding, the technical solution of the present disclosure can be embodied in the form of a software product, which is stored in a storage medium (such as ROM/RAM, magnetic disk and optical disk) and includes several instructions to make a terminal device (which can be a mobile phone, a computer, a server or a network device, etc.) execute the methods described in various embodiments of the present disclosure.

Those skilled in the art should understand that the above-mentioned modules or steps of the present disclosure can be realized by general computing apparatuses, which can be centralized on a single computing apparatus or distributed on a network composed of multiple computing apparatuses. Or, they can be realized by program codes executable by computing apparatuses, so that they can be stored in storage apparatuses and executed by computing apparatuses, and in some cases, the steps shown or described may be performed in a different order from here, or they may be made into individual integrated circuit modules, or a plurality of them or steps may be made into a single integrated circuit module. As such, the present disclosure is not limited to any particular combination of hardware and software.

The above is only an alternative embodiment of the present disclosure, and it is not used to limit the present disclosure. For those skilled in the art, the present disclosure can be modified and varied. Any modification, equivalent substitution, improvement, etc. made within the principles of the present disclosure shall be included in the protection scope of the present disclosure.

1. A method for maintaining candidate cell configuration, performed by a first network node and comprising:
initiating an update process on candidate cell configuration or candidate cell group configuration with a second network node;
wherein the first network node requests the candidate cell configuration or the candidate cell group configuration, and the second network node provides the candidate cell configuration or the candidate cell group configuration.

2. The method according to claim 1, wherein the initiating an update process on candidate cell configuration or candidate cell group configuration with a second network node comprises:
sending a first update request message to the second network node, wherein the first update request message requests to initiate the update process on the candidate cell configuration or the candidate cell group configuration;
wherein, in a case that the first update request message requests to update the candidate cell configuration, the first update request message requests to at least one of:
add a new candidate cell,
delete a candidate cell,
change a candidate cell,
change a cell type of a candidate cell,
change cell configuration of a candidate cell,
reference configuration corresponding to delta configuration on a condition that the delta configuration is adopted for the candidate cell configuration, or
a purpose of a candidate cell; and
in a case that the first update request message requests to update the candidate cell group configuration, the first update request message requests to at least one of:
add a new candidate cell group,
delete a candidate cell group,
change candidate cells designated in a candidate cell group,
change a cell group type of a candidate cell group,
change cell group configuration of a candidate cell group,
reference configuration corresponding to delta configuration on a condition that the delta configuration is adopted for the candidate cell group configuration, or
a purpose of a candidate cell group.

3. (canceled)

4. The method according to claim 2, further comprising:
receiving a first update feedback message from the second network node;
wherein, in a case that the first update request message requests to update the candidate cell configuration, the first update feedback message indicates at least one of:
a newly added candidate cell,
newly added cell configuration of a candidate cell,
a current candidate cell,
a deleted candidate cell,
a changed candidate cell,
a changed cell type of a candidate cell,
changed cell configuration of a candidate cell,
reference configuration corresponding to delta configuration on a condition that the delta configuration is adopted for the candidate cell configuration, or
a purpose of a candidate cell; and
in a case that the first update request message requests to update the candidate cell group configuration, the first update feedback message indicates at least one of:
a newly added candidate cell group,
newly added cell group configuration of a candidate cell group,
a current candidate cell group,
a deleted candidate cell group,
a changed candidate cell group,
a changed cell group type of a candidate cell group,
changed cell group configuration of a candidate cell group,
reference configuration corresponding to delta configuration on a condition that the delta configuration is adopted for the candidate cell group configuration, or
a purpose of a candidate cell group.

5. (canceled)

6. The method according to claim 1, wherein the initiating an update process on candidate cell configuration or candidate cell group configuration with a second network node comprises:
receiving a second update request message sent by the second network node, wherein the second update request message requests to initiate the update process on the candidate cell configuration or the candidate cell group configuration;
wherein, in a case that the second update request message requests to update the candidate cell configuration, the second update request message requests to at least one of:
add a new candidate cell,
add new cell configuration of a candidate cell,
a current candidate cell,
delete a candidate cell,
change a candidate cell,
change a cell type of a candidate cell,
change cell configuration of a candidate cell,
reference configuration corresponding to delta configuration on a condition that the delta configuration is adopted for the candidate cell configuration, or
a purpose of a candidate cell; and
in a case that the second update request message requests to update the candidate cell group configuration, the second update request message requests to at least one of:
add a new candidate cell group,
add new cell group configuration of a candidate cell group,
a current candidate cell group,
delete a candidate cell group,
change a candidate cell group,
change a cell group type of a candidate cell group,
change cell group configuration of a candidate cell group,
reference configuration corresponding to delta configuration on a condition that the delta configuration is adopted for the candidate cell group configuration, or
a purpose of a candidate cell group.

7. (canceled)

8. The method according to claim 6, further comprising:
sending a second update feedback message to the second network node;
wherein, in a case that the second update request message requests to update the candidate cell configuration, the second update feedback message indicates at least one of:
acceptance to adding a new candidate cell,
acceptance to a current candidate cell,
acceptance to deleting a candidate cell,
acceptance to changing a candidate cell,
acceptance to changing a cell type of a candidate cell,
acceptance to changing cell configuration of a candidate cell,
rejection to adding a new candidate cell,
rejection to deleting a candidate cell,
rejection to changing a candidate cell
rejection to changing a cell type of a candidate cell,
rejection to changing cell configuration of a candidate cell,
reference configuration corresponding to delta configuration on a condition that the delta configuration is adopted for the candidate cell configuration, or
a purpose of a candidate cell; and
in a case that the second update request message requests to update the candidate cell group configuration, the second update feedback message indicates at least one of:
acceptance to adding a new candidate cell group,
acceptance to a current candidate cell group,
acceptance to deleting a candidate cell group,
acceptance to changing candidate cells designated in a candidate cell group,
acceptance to changing a cell group type of a candidate cell group,
acceptance to changing cell group configuration of a candidate cell group,
rejection to adding a new candidate cell group,
rejection to deleting a candidate cell group,
rejection to changing candidate cells designated in a candidate cell group,
rejection to changing a cell group type of a candidate cell group,
rejection to changing cell group configuration of a candidate cell group,
reference configuration corresponding to delta configuration on a condition that the delta configuration is adopted for the candidate cell group configuration, or
a purpose of a candidate cell group.

9. (canceled)

10. The method according to claim 2, wherein,
the candidate cell is identified by a candidate cell identifier comprising at least one of: a cell global identifier, a frequency point, a physical cell identifier or a cell type;
the candidate cell group is identified by a candidate cell group identifier comprising at least one of: a candidate cell identifier of each candidate cell comprised in the candidate cell group, a candidate cell group configuration identifier, or a candidate cell group type.

11. The method according to claim 1, wherein the first network node comprises at least one of:
a serving master node,
a serving secondary node, or
a potential target master node;
wherein the second network node comprises at least one of:
a potential target master node,
a potential target secondary node, or
a serving secondary node;
wherein the method further comprises:
in a case that the first network node comprises the serving secondary node, the second network node comprises the potential target secondary node, and the first network node sends a first update request message to the second network node, sending updated candidate cell configuration or updated candidate cell group configuration to the serving master node;
in a case that the first network node comprises the potential target master node, the second network node comprises the potential target secondary node, and the first network node sends the first update request message to the second network node, sending the updated candidate cell configuration or the updated candidate cell group configuration to the serving master node; and
in a case that the first network node comprises the potential target master node, the second network node comprises the potential target secondary node, and the second network node sends a second update request message to the first network node, sending the updated candidate cell configuration or the updated candidate cell group configuration to the serving master node.

12. (canceled)

13. (canceled)

14. The method according to claim 1, wherein the first network node comprises a serving master node, and the method further comprises:
sending updated candidate cell configuration or updated candidate cell group configuration to a terminal device.

15. A method for maintaining candidate cell configuration, performed by a second network node and comprising:
initiating an update process on candidate cell configuration or candidate cell group configuration with a first network node;
wherein the first network node requests the candidate cell configuration or the candidate cell group configuration, and the second network node provides the candidate cell configuration or the candidate cell group configuration.

16. The method according to claim 15, wherein the initiating an update process on candidate cell configuration or candidate cell group configuration with a first network node comprises:
receiving a first update request message sent by the first network node, wherein the first update request message requests to initiate the update process on the candidate cell configuration or the candidate cell group configuration;
wherein, in a case that the first update request message requests to update the candidate cell configuration, the first update request message requests to at least one of:
add a new candidate cell,
delete a candidate cell,
change a candidate cell,
change a cell type of a candidate cell,
change cell configuration of a candidate cell,
reference configuration corresponding to delta configuration on a condition that the delta configuration is adopted for the candidate cell configuration, or
a purpose of a candidate cell; and
in a case that the first update request message requests to update the candidate cell group configuration, the first update request message requests to at least one of:
add a new candidate cell group,
delete a candidate cell group,
change candidate cells designated in a candidate cell group,
change a cell group type of a candidate cell group,
change cell group configuration of a candidate cell group,
reference configuration corresponding to delta configuration on a condition that the delta configuration is adopted for the candidate cell group configuration, or
a purpose of a candidate cell group.

17. (canceled)

18. The method according to claim 16, further comprising:
sending a first update feedback message to the first network node;
wherein, in a case that the first update request message requests to update the candidate cell configuration, the first update feedback message indicates at least one of:
a newly added candidate cell,
newly added cell configuration of a candidate cell,
a current candidate cell,
a deleted candidate cell,
a changed candidate cell,
a changed cell type of a candidate cell,
changed cell configuration of a candidate cell,
reference configuration corresponding to delta configuration on a condition that the delta configuration is adopted for the candidate cell configuration, or
a purpose of a candidate cell; and
in a case that the first update request message requests to update the candidate cell group configuration, the first update feedback message indicates at least one of:
a newly added candidate cell group,
newly added cell group configuration of a candidate cell group,
a current candidate cell group,
a deleted candidate cell group,
a changed candidate cell group,
a changed cell group type of a candidate cell group,
changed cell group configuration of a candidate cell group,
reference configuration corresponding to delta configuration on a condition that the delta configuration is adopted for the candidate cell group configuration, or
a purpose of a candidate cell group.

19. (canceled)

20. The method according to claim 15, wherein the initiating an update process on candidate cell configuration or candidate cell group configuration with a first network node comprises:
sending a second update request message to the first network node, wherein the second update request message requests to initiate the update process on the candidate cell configuration or the candidate cell group configuration;
wherein, in a case that the second update request message requests to update the candidate cell configuration, the second update request message requests to at least one of:
add a new candidate cell,
add new cell configuration of a candidate cell,
a current candidate cell,
delete a candidate cell,
change a candidate cell,
change a cell type of a candidate cell,
change cell configuration of a candidate cell,
reference configuration corresponding to delta configuration on a condition that the delta configuration is adopted for the candidate cell configuration, or
a purpose of a candidate cell; and
in a case that the second update request message requests to update the candidate cell group configuration, the second update request message requests to at least one of:
add a new candidate cell group,
add new cell group configuration of a candidate cell group,
a current candidate cell group,
delete a candidate cell group,
change a candidate cell group,
change a cell group type of a candidate cell group,
change cell group configuration of a candidate cell group,
reference configuration corresponding to delta configuration on a condition that the delta configuration is adopted for the candidate cell group configuration, or
a purpose of a candidate cell group.

21. (canceled)

22. The method according to claim 20, further comprising:
receiving a second update feedback message sent by the first network node;
wherein, in a case that the second update request message requests to update the candidate cell configuration, the second update feedback message indicates at least one of:
acceptance to adding a new candidate cell,
acceptance to a current candidate cell,
acceptance to deleting a candidate cell,
acceptance to changing a candidate cell,
acceptance to changing a cell type of a candidate cell,
acceptance to changing cell configuration of a candidate cell,
rejection to adding a new candidate cell,
rejection to deleting a candidate cell,
rejection to changing a candidate cell,
rejection to changing a cell type of a candidate cell,
rejection to changing cell configuration of a candidate cell,
reference configuration corresponding to delta configuration on a condition that the delta configuration is adopted for the candidate cell configuration, or
a purpose of a candidate cell; and
in a case that the second update request message requests to update the candidate cell group configuration, the second update feedback message indicates at least one of:
acceptance to adding a new candidate cell group,
acceptance to a current candidate cell group,
acceptance to deleting a candidate cell group,
acceptance to changing candidate cells designated in a candidate cell group,
acceptance to changing a cell group type of a candidate cell group,
acceptance to changing cell group configuration of a candidate cell group,
rejection to adding a new candidate cell group,
rejection to deleting a candidate cell group,
rejection to changing candidate cells designated in a candidate cell group,
rejection to changing a cell group type of a candidate cell group,
rejection to changing cell group configuration of a candidate cell group,
reference configuration corresponding to delta configuration on a condition that the delta configuration is adopted for the candidate cell group configuration, or
a purpose of a candidate cell group.

23. (canceled)

24. The method according to claim 16, wherein,
the candidate cell is identified by a candidate cell identifier comprising at least one of: a cell global identifier, a frequency point, a physical cell identifier or a cell type;
the candidate cell group is identified by a candidate cell group identifier comprising at least one of: a candidate cell identifier of each candidate cell comprised in the candidate cell group, a candidate cell group configuration identifier, or a candidate cell group type.

25. The method according to claim 15, wherein the first network node comprises at least one of:
a serving master node,
a serving secondary node, or
a potential target master node;
wherein the second network node comprises at least one of:
a potential target master node,
a potential target secondary node, or
a serving secondary node.

26. (canceled)

27. A method for maintaining candidate cell configuration, performed by a terminal device and comprising:
receiving updated candidate cell configuration or candidate cell group configuration.

28. The method according to claim 27, wherein
the updated candidate cell configuration or the updated candidate cell group configuration adopts a delta configuration mode; or,
the updated candidate cell configuration or the updated candidate cell group configuration adopts a full configuration mode;
wherein the updated candidate cell configuration or the updated candidate cell group configuration adopts a delta configuration mode;
reference configuration of the updated candidate cell configuration or the updated candidate cell group configuration comprises at least one of:
reference configuration corresponding to first issued candidate cell configuration or candidate cell group configuration;
reference configuration corresponding to previously issued candidate cell configuration or candidate cell group configuration;
merged configuration obtained by merging first issued candidate cell configuration or candidate cell group configuration with corresponding reference configuration;
merged configuration obtained by merging previously issued candidate cell configuration or candidate cell group configuration with corresponding reference configuration;
first issued candidate cell configuration or candidate cell group configuration;
previously issued candidate cell configuration or candidate cell group configuration;
designated cell configuration or cell group configuration;
cell configuration of a first cell currently serving, wherein a cell type of the first cell is the same as a cell type of an updated candidate cell; or, cell group configuration of a first cell group currently serving, wherein a cell group type of the first cell group is the same as a cell group type of an updated candidate cell group;
cell configuration of a second cell, wherein a configuration identifier of the second cell is the same as a configuration identifier of an updated candidate cell; or, cell group configuration of a second cell group, wherein a configuration identifier of the second cell group is the same as a configuration identifier of the updated candidate cell group; or
cell configuration of a third cell, wherein a cell identifier of the third cell is the same as a cell identifier of an updated candidate cell; or, cell group configuration of a third cell group, wherein a cell group identifier of the third cell group is the same as a cell group identifier of the updated candidate cell group.

29.-32. (canceled)

33. A network device, comprising:
a processor; and
a transceiver connected to the processor;
wherein the transceiver is configured to perform the method according to claim 1.

34. A network device, comprising:
a processor; and
a transceiver connected to the processor;
wherein the transceiver is configured to perform the method according to claim 15.

35. A terminal device, comprising:
a processor; and
a transceiver connected to the processor;
wherein the transceiver is configured to perform the method according to claim 27.

36.-38. (canceled)
